(19) United States
(12) Patent Application Publication
(10) Pub. No.: US 2018/0043447 A1
(43) Pub. Date: Feb. 15, 2018

(54) METHOD FOR OPERATING AN ELECTRICAL MACHINE AND ELECTRICAL MACHINE

(71) Applicant: Brose Fahrzeugteile GmbH & Co. Kommanditgesellschaft, Wuerzburg, Wuerzburg (DE)

(72) Inventor: Johannes SCHWARZKOPF, Marktheidenfeld (DE)

(73) Assignee: Brose Fahrzeugteile GmbH & Co. Kommanditgesellschaft, Wuerzburg, Wuerzburg (DE)

(21) Appl. No.: 15/677,584

(22) Filed: Aug. 15, 2017

(30) Foreign Application Priority Data
Aug. 15, 2016 (DE) 10 2016 215 174.6

(51) Int. Cl. B23H 1/02; B60L 11/02; B60K 6/28; B23K 11/24; B60K 6/40

(52) U.S. Cl. CPC B23H 1/028; B23K 11/24; B60K 6/40; B60K 6/28; B60L 11/02

(57) ABSTRACT

A method for operating an electric machine with a power source and with an electric motor and with an intermediary power converter, wherein an input current of the power source is converted into a multi-phase output current for the electric motor by means of a pulse width modulated control of a plurality of semiconductor switches of the converter, wherein during each period of control, for at least one phase, a pulse with a pulse duration is generated during a period duration, wherein in a period, a pulse is divided into a leading first half-pulse and a trailing second half-pulse with in each case half a pulse duration, and wherein the first half-pulse with a first displacement time and the second half-pulse with a second displacement time are mutually shifted in time within the period duration of the period.

This nonprovisional application claims priority under 35 U.S.C. §119(a) to German Patent Application No. 10 2016 215 174.6, which was filed in Germany on Aug. 15, 2016, and which is herein incorporated by reference.

### BACKGROUND OF THE INVENTION

### Field of the Invention

The invention relates to a method for operating an electrical machine with a power source and with an electric motor as well as with an intermediary power converter, in which an input current of the power source is converted by means of a pulse width modulated control of a number of semiconductor switches of the power converter into a multiphase output current for the electric motor. The invention further relates to an electric machine operated by such a method, in particular for a motor vehicle.

### Description of the Background Art

Adjustment systems driven by an electric motor used as motor vehicle components, such as, for example, window regulators, seat adjusters, door and sliding roof drives or radiator fan drives, as well as pumps and interior fans, typically have an electric machine with a controlled electric motor. For example, brushless electric motors are known in which a rotor rotatably mounted relative to a stator is driven by a magnetic rotating field. For this purpose, phase windings of the stator are subjected to a corresponding electrical three-phase or motor current, which is controlled and regulated by means of a controller as part of a (motor) electronics.

Such electrical machines generally comprise a (high-voltage) battery as an internal energy storage device from which the electric motor is supplied with electrical energy in the form of a direct current. For converting the direct current into the motor current, a converter (inverter, power inverter) is suitably connected between the energy store and the electric motor. A (direct voltage) intermediate circuit is connected downstream of the energy store, to which a bridge circuit of the power converter is connected. The energy store and the intermediate circuit act as a power source for providing the input-side direct current (input current) for the converter. The motor current is generated by a pulse width modulated (PWM) control of semiconductor switches of the bridge circuit as a multiphase output current. By the pulses of the PWM control, the semiconductor switches are switched over in clocked fashion between a conducting state and a blocking state.

By means of the switching processes of the semiconductor switches, alternating currents are generated in the lines of the intermediate circuit or of the power source. These alternating currents must undergo a critical assessment in respect of compliance with EMC directives (electromagnetic compatibility).

### SUMMARY OF THE INVENTION

It is therefore an object of the invention to provide a particularly suitable method for operating an electrical machine. In particular, the EMC behavior of the electrical machine is to be improved during operation. The invention is also based on the object of specifying an electrical machine operating in accordance with such a method.

The method according to the invention is suitable and arranged for operating an electrical machine. The electrical machine in this case has an energy store with a downstream (direct current) intermediate circuit, which together are designed as a power source (voltage supply) for an electric motor of the machine. A converter, for example in the form of an inverter (power inverter), is connected between the power source and the electric motor.

During operation of the machine, the converter converts an input current of the power source into a multiphase, in particular three-phase, output current (motor current, three-phase current) for the electric motor. For this purpose, a number of semiconductor switches of the converter connected in the intermediate circuit are controlled in clocked fashion with a pulse width modulated (PWM) control. In each period, for at least one phase, the PWM control has a pulse-shaped signal (pulse) for switching the respective semiconductor switches, which is generated during a respective period duration. The (signal) pulse has a pulse duration, that is to say a length of time during which the semiconductor switch is switched (active time).

The method provides that in an activation period, a pulse is divided into a leading half-pulse, that is, a half-pulse which occurs earlier in the period duration, and into a trailing second half-pulse, that is, a half-pulse which occurs later in the period duration, having in each case half a pulse duration. The first half-pulse with a first displacement time and the second half-pulse with a second displacement time are mutually shifted in time within the period duration of the period. In other words, this results in a pulse shift within a phase. This way, the periodicity of an alternating current, which is generated in the intermediate circuit of the power source during the pulse width modulated control of the semiconductor switches, is deliberately disturbed. As a result, the alternating current component in the (PWM) clock frequency is reduced, which on the one hand reduces the load on the power or voltage source.

In an embodiment, the first half-pulse is delayed in time with the first displacement time in the period, which means that the first half-pulse is generated at a later point in time in the period duration. The second half-pulse is thereby accelerated in time with the second displacement time in the period, which means that the second half-pulse is generated at an earlier point in time in the period duration. In particular, the second half-pulse is generated prior to the first half-pulse. This means that the first half-pulse leading prior to displacement, then trails the second half-pulse after displacement. This ensures that the half-pulses remain with the period. In other words, the common active time in a phase does not change during the period, whereby the machine operation is not adversely affected.

The shift essentially changes the sequence of the half-pulses during the period. Since both half-pulses are substantially identical, it is alternatively also possible to retain the time sequence of the half-pulses within the period, wherein the respective displacement times of the first and second half-pulse are reduced in value.

In an embodiment, a fraction of the period duration (70) with an even-numbered denominator, in particular half the period duration (70), is set for the pulse (P_{V}, P_{W}) during the period duration (70) as the first and/or second displacement time (_{T1}, _{T2}). Preferably, a power of two (2ⁿ, nεN₀), is used as the denominator. In particular, n=1 is used, which means that the first and/or second displacement time equals half the period duration. By means of such a displacement by half a period duration, the amplitude of the alternating current component—and of the EMC-critical magnetic field emission thus produced—is reduced at the clock frequency of the PWM control. Accordingly, for n=2, i.e., with a displacement by a quarter of the period duration, the alternating current components (frequency components) are reduced at the doubled clock frequency.

In an embodiment, the first and second displacement time of the (half-)pulse are set substantially equal in magnitude during the period. In other words, the first and second displacement time have the same value, wherein the second displacement time has a different sign than the first displacement time due to the different displacement direction. This way, a simple and economical displacement of the half-pulses is realized.

In an embodiment, the duration of the first and/or second displacement time of the pulse is changed for successive periods. In other words, the displacement times are changed from pulse to pulse. Thus, the periodicity of the generated alternating current components is reliably reduced so that the amplitudes can be reduced in the repetition rates or clock frequencies involved.

In an embodiment, it is for example conceivable, that the displacement times of each second period of the PWM control are set to zero, that is, no displacement is performed. In other words, a displacement of the half-pulses only takes place every second period. For example, in a displacement with a first and a second displacement time equal to half the period duration, an inversion of the phase position is generated every second period on the alternating current component at the clock frequency. This ensures that the alternating current component is reduced at the clock frequency.

In an embodiment, a plurality of successive periods have, for example, the same displacement times for the respective pulses. In other words, several pulses of successive periods are, for example, displaced or not displaced.

In an embodiment, the duration of the first and/or the second displacement time of the pulse for each period is randomly modified. In other words, the pulses of successive periods coincidentally have different displacement times. Due to the mutual, randomly set displacement of the pulses of the periods, a particularly irregular or non-periodic disruption of the alternating current periodicity is produced. This way, the amplitude or the spectral weight of the alternating current component at the clock frequency is divided to as many different frequencies as possible. In other words, the spectrum is broadened or made broadband, wherein the alternating current components thereby generated have in each case a comparatively low amplitude, which can be dampened or reduced by means of filtering circuits of the intermediate circuit.

The period duration of successive periods can be varied. This way, the periodicity of the generated alternating current components is further disrupted so that the amplitudes of the relevant alternating current components are reliably reduced.

In an embodiment, the first and/or second displacement time for pulses of varying phases are set differently. This means that the pulses of varying phases have different displacements, or that one or more phases have no displacements. In other words, it is possible that the displacements are not applied to all phases. This has a positive effect on a further reduction of the alternating current components.

In an embodiment, a first and/or second displacement time for pulses of varying phases is used in periods that differ from one another. This ensures a particularly effective dampening or reduction of the alternating current components.

In an embodiment, the electric machine is particularly suitable and configured for the electromotive drive in a motor vehicle, for example for an adjustment system used as a motor vehicle component. The electric motor is preferably designed brushless with a stator and with a rotor rotatably mounted therein. The stator has a number of phase windings which, on the one hand, are connected to the converter and, on the other hand, are interconnected, for example, by a common connection point (star point) in a star connection.

The converter has a controller, which means a control unit. In this case, the controller is generally suitable and configured for the implementation of the method described above, in a programmatic and/or circuit-engineering manner. The controller is thus specifically configured to perform a modulation of the PWM control during operation, in which pulses of the phases are divided and displaced within a period.

In an embodiment, the controller can be formed, at least in the core, by a microcontroller with a processor and a data memory, in which the functionality for carrying out the inventive method is programmatically implemented in the form of an operating software (firmware), so that the method—possibly interacting with the user—is executed automatically when the operating software is executed in the microcontroller.

The controller can alternatively also be formed by a non-programmable electronic component, for example an ASIC (application-specific integrated circuit), in which the functionality for implementing the method is implemented using a circuit.

The electrical machine operated with the method thus has improved behavior with regard to EMC radiation as well as with regard to the noise development occurring as a result of the switching processes of the semiconductor switches. The method according to the invention is particularly suitable and adapted for use in speed-controlled systems. In principle, the application is not restricted to the automobile sector.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates an electrical machine with a power source and with an electric motor as well as an power converter connected therebetween,

FIG. 2 illustrates three phase windings of a three-phase electric motor of the machine in star connection,

FIG. 3 illustrates a bridge module of a bridge circuit of the converter for controlling a phase winding of the electric motor,

FIG. 4 illustrates an equivalent circuit diagram of the power source, and

FIG. 5 is a diagram of a PWM control of the phase windings.

### DETAILED DESCRIPTION

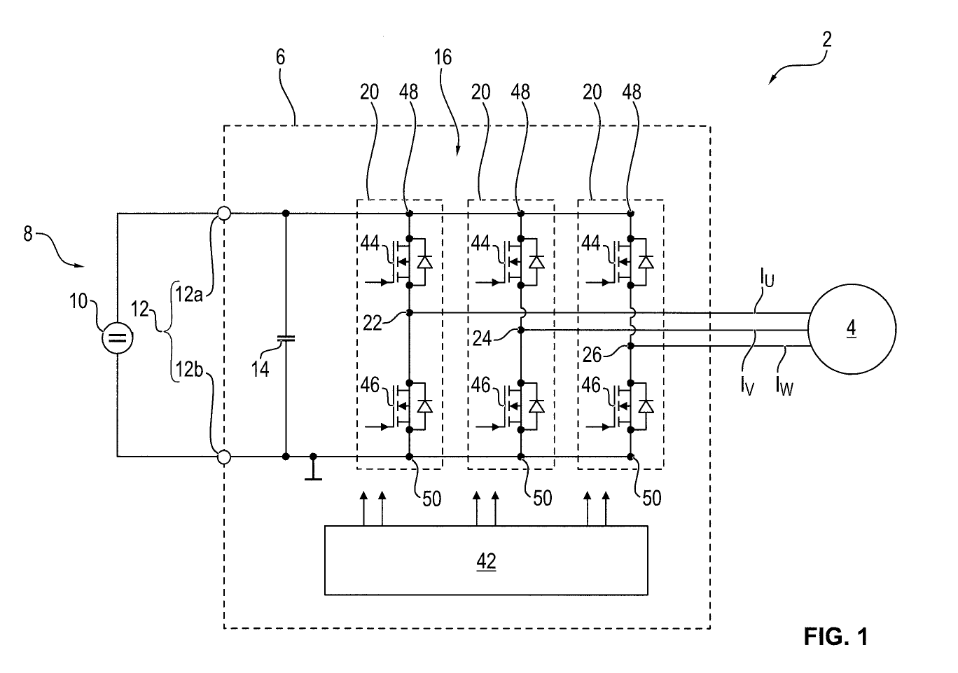

FIG. 1 shows an electrical machine 2 for an electromotive adjustment system of a motor vehicle (not shown), for example a window lifter or a seat adjuster. For this purpose, the machine 2 comprises a three-phase electric motor 4, which is connected by means of a power converter 6 to a power source (voltage supply) 8. In this exemplary embodiment, the power source 8 comprises an energy storage device 10 inside the vehicle, for example in the form of a (motor vehicle) battery, as well as a (DC) intermediate circuit 12 which is connected to it and which at least partially extends into the converter 6.

The intermediate circuit 12 is essentially formed by a feed line 12a and a return line 12b, by means of which the converter 6 is connected to the energy store 10. The lines 12a and 12b are at least partially guided into the converter 6, in which a DC link capacitor 14 and a bridge circuit 16 are connected between the lines.

During operation of the engine 2, an input current I_{E} supplied to the bridge circuit 16 is converted into a three-phase output current (motor current, phase current) I_{U}, I_{V}, I_{W}

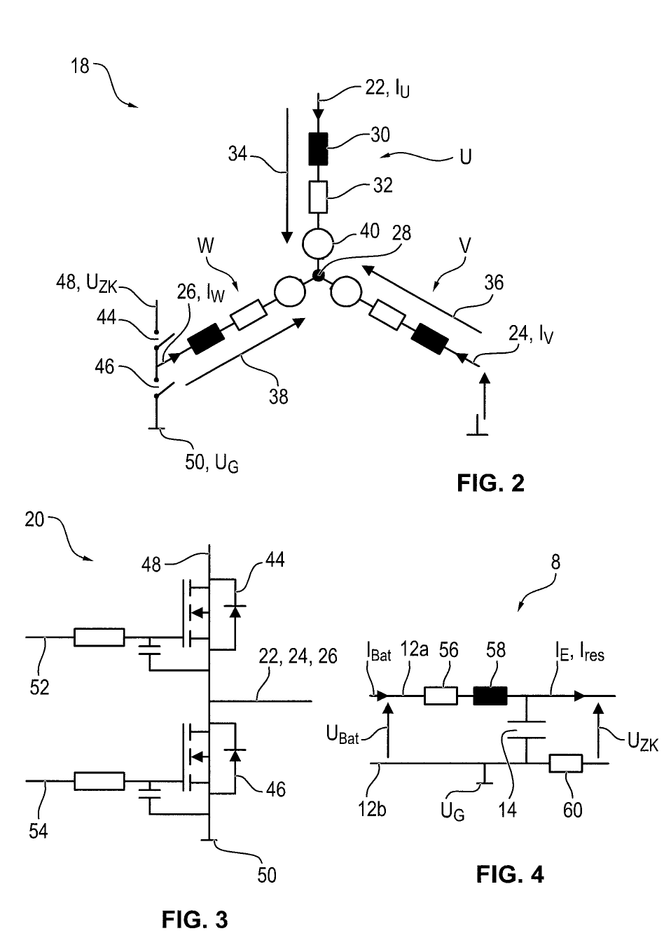

for the three phases U, V, W of the electric motor 4. The output currents I_{U}, I_{V}, I_{W}, hereafter also known as phase currents, are guided to the respective phases (windings) U, V, W (FIG. 2) of a stator, not shown.

A star circuit 18 of the three phase windings U, V, W is shown in FIG. 2. The phase windings U, V and W are each connected with a respective (phase) end 22, 24, 26 to a respective bridge module 20 (FIG. 3) of the bridge circuit 16 and interconnected with the respective opposite end in a star point 28 as a common connection terminal. In the illustration in FIG. 2, the phase windings U, V and W are each shown by means of an equivalent circuit diagram in the form of an inductor 30 and an ohmic resistance 32 as well as a respective voltage drop 34, 36, 38. The voltage 34, 36, 38, which drops across the phase winding U, V, W, is schematically represented by arrows, and is the sum of the voltage drops across the inductor 30 and the ohmic resistance 32 as well as the induced voltage 40. The voltage 40 induced by a movement of the rotor of the electric motor 4 (electromagnetic force, EMF) is shown in FIG. 2 by means of a circle.

The star circuit 18 is triggered by means of the bridge circuit 16. The bridge circuit 16 with the bridge modules 20 is designed, in particular, as a B6 circuit. In this embodiment, during operation, a high (DC) voltage level of the feed line 12a and a low voltage level of the return line 12b are switched over at a high switching frequency in clocked fashion to each of the phase windings U, V, W. The high voltage level is in this case in particular an intermediate circuit voltage U_{ZK} of the intermediate circuit 12, wherein the low voltage level is preferably a ground potential U_{G}. This clocked control is implemented as a PWM control, represented in FIG. 1 by means of arrows, by a controller 42, with which control and/or regulation of the speed, the power and the direction of rotation of the electric motor 4 is possible.

The bridge modules 20 each comprise two semiconductor switches 44 and 46, which are shown schematically and exemplarily for the phase W in FIG. 2. The bridge module 20 is connected on the one hand with a potential terminal 48 to the feed line 12a and hence to the intermediate circuit voltage U_{ZK}. On the other hand, the bridge module 20 is contacted with a second potential terminal 50 to the return line 12b and thus to the ground potential U_{G}. Via the semiconductor switches 44, 46, the respective phase end 22, 24, 26 of phase U, V, W can be connected either to the intermediate circuit voltage U_{ZK} or to the ground potential U_{G}. When the semiconductor switch 44 is closed (conducting) and the semiconductor switch 46 open (non-conductive, blocking), the phase end 22, 24, 26 is connected to the potential of the intermediate circuit voltage U_{ZK}. Accordingly, the phase U, V, W contacts the ground potential U_{G} upon opening the semiconductor switch 44 and closing the semiconductor switch 46. As a result, it is possible by means of the PWM control to apply two different voltage levels to each phase winding U, V, W.

In FIG. 3, a single bridge module 20 is shown in simplified form. In this exemplary embodiment, the semiconductor switches 44 and 46 are implemented as MOSFETs (metal-oxide semiconductor field-effect transistors), each of which are switched over in clocked fashion by means of the PWM control between a switched-on state and a blocking state. For this purpose, the respective gate connections are routed to corresponding control voltage inputs 52, 54, by means of which the signals of the PWM control of the controller 42 are transmitted.

FIG. 4 shows an equivalent circuit diagram for the power source 8. During operation, the energy storage 10 generates a battery voltage U_{Bat} and a corresponding battery current I_{bat} for the operation of the power converter 6. In FIG. 4, the internal resistance of the energy storage 10 is shown as an ohmic resistor 56, and a self-inductance of the energy storage device 10 as an inductor 58. A shunt resistor 60 is connected in the return line 12b, at which the intermediate circuit voltage U_{ZK} drops.

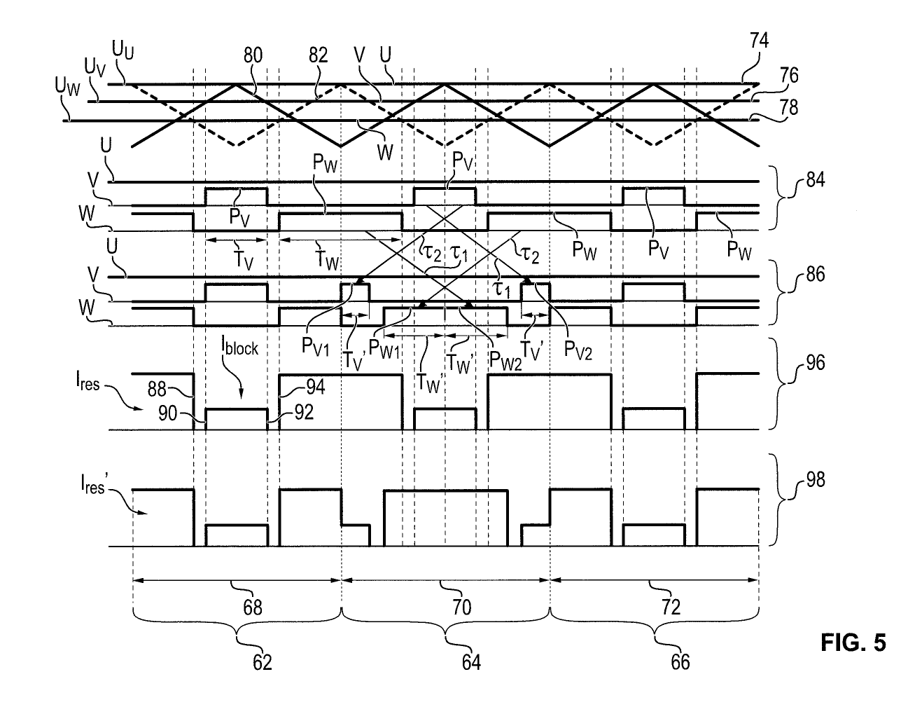

FIG. 5 subsequently shows and describes the waveform on the individual phase terminals 22, 24, 26, and how the voltage or PWM signals can advantageously be controlled or regulated at the individual phase windings U, V, W, as well as which consequences result therefrom with respect to the currents I_{U}, I_{V}, I_{W} in the phase windings U, V, W and the input current I_{E} of the external power source 8. In the embodiment in FIG. 5, the phase winding U is applied to a constant, low voltage potential, i.e. in particular, to ground potential U_{G}. The phases V and W are supplied with the pulse width modulated control signals.

The diagram in FIG. 5 comprises five horizontal, superimposed sections. The time is plotted horizontally, i.e., on the x-axis or abscissa axis. By way of example, three periods 63, 64, 66 of the PWM control are shown in FIG. 5, a period 62, 64, 66 in each case having a period duration 68, 70 and 72, which here, for example, is between 20 μs (microseconds) and 50 μs.

FIG. 5 shows a PWM control in which the phase terminals 22, 24, 26 of the electric motor 4 are each actuated with a PWM (pulse) signal P_{V}, P_{W} of a different duty cycle. The current desired voltages U_{U}, U_{V} U_{W} of the three phases U, V and W are shown in FIG. 5 with an instantaneous value 74, 76 and 78 respectively shown as a horizontal line. In this case, the desired voltage values vary over the time as a function of the rotational speed of the electric motor 4 in each case in the manner of a sinusoidal function. This causes the lines of the instantaneous values 74, 76 and 78 to move up and down periodically in the vertical direction, i.e., along the Y-axis or ordinate axis.

The saw tooth-shaped line in the upper section of the diagram represents a periodically linearly increasing and linearly decreasing counter reading 80 of a counter integrated in the controller 42. The points of intersection between the thresholds of the individual phases U, V, W which are fixed for a specific point in time, that is to say, the instantaneous values 74, 76, 78 with the saw tooth-like counter reading 80, represent the point in time for generating and terminating the (PWM) pulses P_{V}, P_{W}, with which the phase windings U, V, W are applied. This means that in the case of a high voltage threshold, the instantaneous value 74, 76, 78 is low, so that the sample time of the pulse-shaped pulse P_{V}, P_{W} is long, that is to say, that the respective phase V, W is supplied with the phase current I_{V}, I_{W} or applied with a voltage for a prolonged time. A counter reading 82, which is phase shifted by 180° relative to the counter reading 80, is shown by dashed lines in FIG. 5.

In the second section 84 and third section 86 of the diagram of FIG. 5, the voltage profiles at the phase terminals 22, 24 and 26 are shown in a time-resolved manner.

In the second section 84, a PWM control is shown in which in each period 62, 64 and 66, always the same pulses P_{V} and P_{W} are generated; in the following, therefore, only the first period 62 is described by way of example. In this exemplary embodiment, the phase W is switched on at the beginning of the period 62 and is switched off at a point in time 88. Delayed in time, a voltage is then applied to the phase winding W at a point in time 90. After a pulse duration T_{V}, at a point in time 92, the pulse PV is terminated. Subsequently, the phase W is switched on at a point in time 94 up to the end of the period 62. The pulse P_{W} thus essentially extends over in each case two adjacent periods 62, 64, 66 during a pulse duration T_{W}. This voltage profile is periodically repeated for the PWM control in the second section 84 with a clock frequency (base frequency) f_{periode}.

In the fourth section 96 and the fifth section 98 of FIG. 5, a respective time profile of the alternating current Iᵣₑₛ, Iᵣₑₛ′ resulting from the PWM control is shown in the power source, for example, in the intermediate circuit 12. Section 96 hereby shows the alternating current Iᵣₑₛ for the PWM control according to section 84, and section 98 shows the alternating current Iᵣₑₛ′ for a PWM control according to section 86.

In section 96, the alternating current Iᵣₑₛ is shown for an operating situation in which the flow direction of the phase currents I_{V} and I_{W} of the phases V and W correspond in terms of the directions from and to the star point 28. The amperage in phase V, for example, is 1 A, and in phase W, the amperage is 3 A. The amperage of phase U, for example, has −4 A and has a flow direction opposite phases V and W. At the beginning of period 62, thus, an alternating current Iᵣₑₛ with the amperage 3 A is generated up to the point in time 88. Accordingly, during the pulse duration TV, an alternating current Iᵣₑₛ of 1 A is generated.

During a period 62, 64, 66, the alternating current Iᵣₑₛ thus has a three-section current block or alternating current component I_{block}, which periodically repeats. By way of example, only the middle current block I_{block} is described below which corresponds to the pulse P_{V}, wherein the two lateral current blocks, generated by the pulse P_{W}, can be similarly described because of the linearity.

By Fourier transform, the alternating current component I_{block} is mapped on a frequency spectrum F_{block}(ω), wherein w is the angular frequency. By application of the displacement law, the following is obtained for the total spectrum F(ω) of alternating-current components I_{block} of several (n) periods of the period duration T_{periode}

F(ω)=Σₙe^{-jωT}^{_{periode}}F_{block}(ω),

wherein j is the imaginary unit. It follows for the clock frequency f_{period} or the respective multiple n×f_{periode} that period or

e^{-jωT}^{_{periode}}=e^{-j2πf}^{_{periode}}^{nT}^{_{periode}}=e^{-j2πn}=1.

This results in that the frequency or alternating current components of the AC current Iᵣₑₛ add up for n×f_{periode}. This results in so-called EMC needles, which adversely affect the EMC behavior of the machine 2.

A method for reducing the EMV needles is described below with reference to sections 86 and 98 of FIG. 5. In the embodiment of FIG. 5, the pulses P_{V} and P_{W} in period 64 are divided in each case into two half-pulses P_{V1} and P_{V2} and P_{W1} and P_{W2} The half-pulses P_{V1} and P_{V2} and P_{W1} and P_{W2} in this case each have a pulse duration T_{V}′ or T_{W}′, which correspond to the respective half, original pulse duration T_{V} or T_{W}. In principle, the method is applicable to all three phases U, V, W. In the embodiment of FIG. 5, phase U is, however, by way of example, permanently at low ground potential U_{G} so that no displacement takes place.

The half-pulses P_{V1}, P_{W1}, P_{V2}, P_{W2} are then displaced by a respective displacement time within the period 64. The half-pulses P_{V1}, and P_{W1} are in this case delayed in time by means of a displacement time _{T1} as compared to the unshifted pulses P_{V} and P_{W} of section 84 in this embodiment. The half-pulses P_{V2} and P_{W2} are temporally accelerated in time with a displacement time _{T2} so that they lead the respectively associated half-pulse P_{V1} and P_{W1} during the period duration 70.

The displacement times _{T1} and _{T2} are equal in magnitude in the illustrated embodiment. In particular, the displacement times _{T1} and _{T2} are equal in magnitude to half the period duration 70. The following applies:

e^{-j2πf}^{_{periode}}^{nT}^{_{periode}}^{/2}=e^{-jπn}=−1.

which means that due to the time shift, a phase shift of 180° is produced by means of the displacement times _{T1} and _{T2}. In other words, the counter reading 80 is converted into the counter reading 82.

The resulting alternating current Iᵣₑₛ′ thus has a phase sequence, which is shifted by 180° during the period 64. As can be seen comparatively clearly in section 98, the periodicity of the alternating current Iᵣₑₛ′ or its alternating-current components is hereby disturbed. Thus, the alternating-current components no longer add up for n×f_{periode}, but instead are distributed over a plurality of frequency components. In the modulation scheme of section 86, preferably such a pulse displacement means is performed each second period by means of the displacement times _{T1} and _{T2}.

The invention is not limited to the embodiment described above. Rather, other variants of the invention can also be derived from those skilled in the art without departing from the scope of the invention. In particular, all the individual features described in connection with the exemplary embodiment can also be combined with one another in another manner without departing from the subject matter of the invention.

For example, it is equally conceivable to vary the period durations 68, 70, 72 such that the periods 62, 64 and 72 have different period durations. It is also conceivable, for example, that a plurality of pulses P_{V}, P_{W} of consecutive periods 68, 70, 72 are shifted in time. It is essential that the active time per phase U, V, W, i.e., the pulse duration, remain substantially constant during a period 62, 64, 66. This results only in a disruption of the periodicity of the alternating current Iᵣₑₛ′, but not of the operation of the electric motor 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating an electric machine with a power source, an electric motor, and an intermediary power converter, the method comprising:
converting an input current of the power source into a multi-phase output current for the electric motor via a pulse width modulated control of a number of semiconductor switches of the converter;
generating, during each period of the control, a pulse with a pulse duration for at least one phase during a period duration;
dividing, in a period, a pulse into a leading, first half-pulse and a trailing, second half-pulse with half a pulse duration; and
mutually shifting in time within the period duration of the period the first half-pulse with a first displacement time and the second half-pulse with a second displacement time.

2. The method according to claim 1, wherein the first half-pulse with the first displacement time is delayed in time within the period, and wherein the second half-pulse with the second displacement time is accelerated in time within the period.

3. The method according to claim 1, wherein a fraction of the period duration with an even-numbered denominator or half of the period duration is set for the pulse during the period duration as the first and/or second displacement time.

4. The method according to claim 1, wherein the first and second displacement time of the pulse are set equal in magnitude during the period.

5. The method according to claim 1, wherein the duration of the first and/or second displacement time of the pulse is modified for successive periods.

6. The method according to claim 5, wherein the duration of the first and/or second displacement time of the pulse is changed at random for each period.

7. The method according to claim 1, wherein the period duration of successive periods is varied.

8. The method according to claim 1, wherein the first and/or second displacement time for pulses of different phases are set differently.

9. The method according to claim 8, wherein the first and/or second displacement time for pulses of different phases are applied in mutually different periods.

10. An electric machine for a motor vehicle, with a power source, an electric motor and an intermediary power converter with a controller for carrying out the method according to claim 1.
